(19) United States
(12) Patent Application Publication
(10) Pub. No.: US 2002/0059240 A1
(43) Pub. Date: May 16, 2002

(54) System for presenting consumer data

(75) Inventors: David B. Hollenbeck, Windsor, CO (US); Phil Yastrow, Fort Collins, CO (US)

Correspondence Address: Santangelo Law Offices, P.C., Third Floor, 125 South Howes, Fort Collins, CO, 80521, US

(73) Assignee: eDave, Inc., Fort Collins, CO (US)

(21) Appl. No.: 10/015,036

(22) Filed: Oct. 25, 2001

Related U.S. Application Data
(60) Provisional application No. 60/243,116, filed on Oct. 25, 2000.

(51) Int. Cl. G06F 7/00

(52) U.S. Cl. 707/9

(57) ABSTRACT

Software based methods to capture consumer data such as purchase or service receipt gratification data and to present composite or individual information back to pre-purchase consumers are provided. In several embodiments, systems and methods for creating and sustaining a database, systems and methods for marking statistical data as potentially suspect (e.g., low integrity or suspicious), systems and methods for presenting data hierarchically (such as in an information pyramid), and systems and methods for fast user interfaces (e.g., five seconds or less) are presented. Additionally, advertising information and claims, consumer report information and claims, adver-torial information and claims, and options to link to other information such as that in web sites, banner advertising information and claims, and access to independent testing organization information and claims are presented. Further, systems for Internet business practices, systems for consumer contact management, and for consumer messaging are presented.

### RELATED APPLICATIONS

This application claims the benefit of U.S. Provisional Application No. 60/243,116 filed on Oct. 25, 2000, herby incorporated by reference.

### BACKGROUND OF THE INVENTION

This invention relates to methods, programs, and configured computers and computing devices to capture consumer data such as purchase or service receipt gratification data and to present composite or individual information back to pre-purchase consumers and the like.

### SUMMARY OF THE INVENTION

In several embodiments, the invention focuses on systems and methods for creating and sustaining a database, systems and methods for marking statistical data as potentially suspect (e.g., low integrity or suspicious), systems and methods for presenting data hierarchically (such as in an information pyramid), and systems and methods for fast user interfaces (e.g., five seconds or less). The present invention may also involve advertising information and claims, consumer report information and claims, adver-torial information and claims, and options to link to other information such as that in web sites, banner advertising information and claims, and access to independent testing organization information and claims. It presents systems for Internet business practices, systems for consumer contact management, and consumer messaging as well.

### DESCRIPTION OF THE DRAWINGS

The accompanying drawings illustrate embodiments of the invention. In the drawings:

FIG. 1 is a graphic of one configuration of information flow and shows how the present invention may be designed with straightforward database involvement.

FIG. 2 is an illustration of one type of hierarchical input structure which may be used in the invention (referred to as “eDave” in the figures).

FIG. 3 illustrates one embodiment of the invention in which a survey format may be designed to communicate significant amounts of information clearly and quickly.

FIG. 4 illustrates one type of hierarchical output structure which may be used in the invention wherein information outputted to the consumer or otherwise may also follow the “information pyramid” structure.

### DETAILED DESCRIPTION OF THE INVENTION

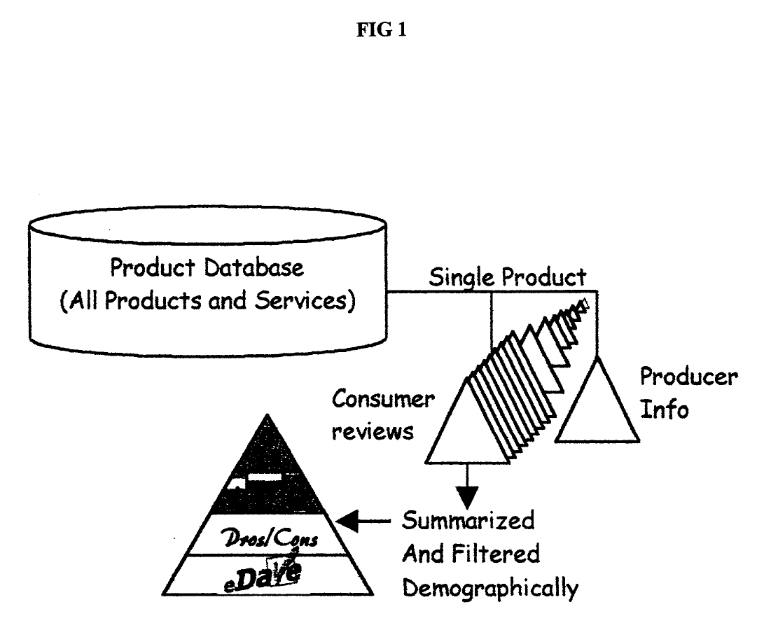

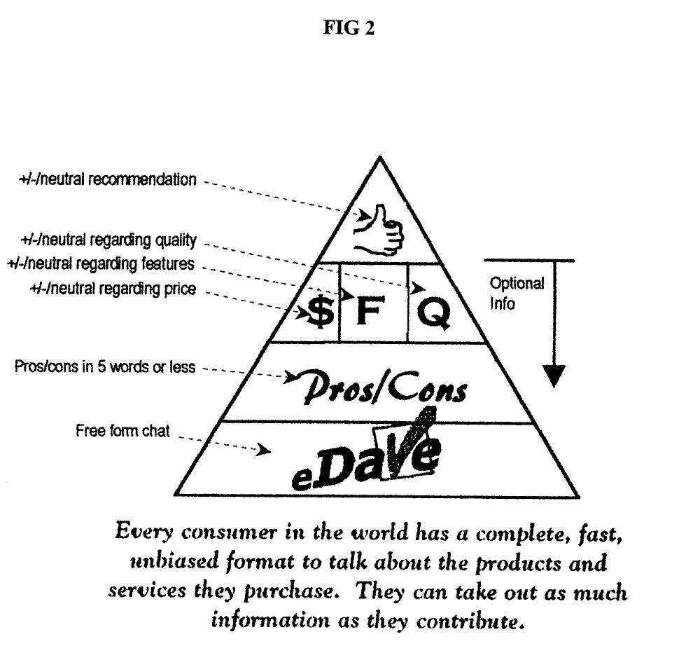

As shown in FIG. 1, a graphic of one configuration of information flow, the present invention may be designed with straightforward database involvement. For example, FIG. 2 illustrates one type of hierarchical input structure which may be used in the invention (referred to as “eDave” in the figures). As can be understood, in the present invention, users may connect to a consumer purchase database or a global computer information network site using a self-selected login name (possibly with, but also importantly without, any other information about themselves). While connected, they may locate (by executing a search, by browsing through a category hierarchy, by entering UPC product codes, by bar code scanning, by any type of product identifier, or by any other technique) a product or service which is a “topic” of opinion. Such product may have consumer purchase information or data (e.g., any type of information or a determinant—such as information enticements or the like) of interest to a consumer. At the particular topic of interest, the user may have multiple choices including but not limited to: an opportunity to complete a short survey regarding their gratification with a purchase or use, or an opportunity to view results of other relevant or even all such surveys, in anticipation of a purchase of their own. For immediacy of information, a cell phone may even incorporate a bar code scanner (or the system may be designed to accept voice or key pad input of product code information). The system may then provide truncated or full information to the cell phone to permit the user to make an immediate buying decision.

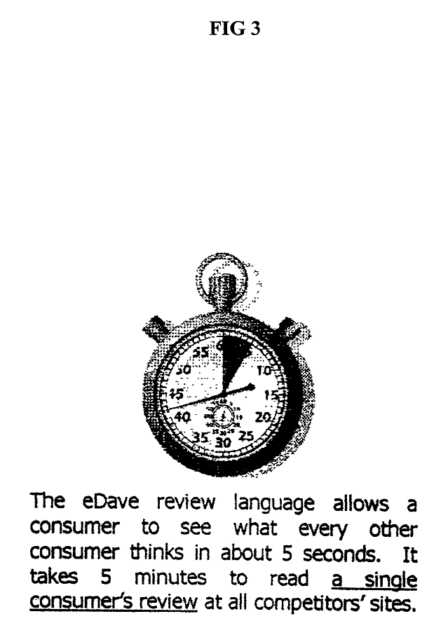

The survey format may or may not be the same as the result display format, and may be designed to communicate significant amounts of information, clearly, and quickly and as such be immediately assimilatable. As illustrated graphically in FIG. 3, it may be designed with an approach following the principle “the answer should be obvious in five seconds or less.” It may also be designed with an approach following the principle that the answer should be obvious immediately, where immediately is defined herein as in three seconds or less, five seconds or less, ten seconds or less, fifteen seconds or less, or twenty seconds or less. The design may even be such that this time parameter or goal may include web page loading time as well. Factors not fully addressed in the potential prior art systems, such as a recognition that verbose reviews take too long to read, such as the fact that rating products from one to five or so is too subjective, such as the lack of assured or actual consumer privacy, or such as the fact that banner advertising is viewed as an annoyance may also be addressed in the design of the system.

User interaction may also be designed for simplicity. An example of potential types of guided inquiries might include questions such as:

Would you recommend it (or something to the effect of “are you satisfied with your purchase” overall);

Would you recommend it to others based on a hierarchy or list of factors such as price, quality, features;

Will you list up to three good points and up to three bad points (perhaps requesting short phrases);

Please indicate your willingness to be contacted (likely anonymously, and likely through the Internet site) by another prospective purchaser.

This type of survey may constitute the format of a “review” in one embodiment of the present invention. Further, answers may be combined with all others for the particular topic (and similarly for all other topics), so that a different user who is a prospective purchaser may see the combined result.

To promote the speed goals mentioned above, the results may be displayed in the same general format as the survey, perhaps with merely a simple percentage of respondents saying “yes” or “no.” A third “neutral” answer may also be available. In the result display, the most frequently reported “pro's” and “con's” may also be listed.

As shown in the Figures, such a format may loosely follow a concept called “the information pyramid,” in which each successive level of reporting is more detailed than the previous. The present invention may use this format to quickly and effectively communicate with the user. Again here the goal may be that the answer should be obvious in five seconds or less, or immediately, as defined herein. At the most detailed level, there may even be a one-on-one contact, with several methods available to obtain or provide the information. A more simple communication technique to incorporate may be the use of an E-mail-styled messaging system. Such a system may use the global information network site of one embodiment as the entire system. This may also be configured so as to allow users to preserve their anonymity. Users may even be asked to formulate their questions and answers such that the present invention may capture them into a “Frequently Asked Questions” format. Over time, the overall or collective knowledge level of the present invention consumer community may thus increase.

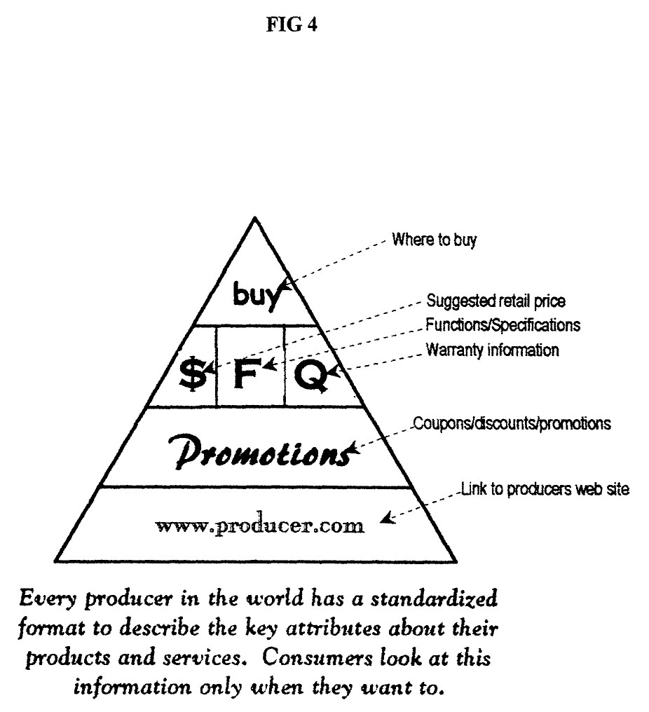

As illustrated in FIG. 4, one type of hierarchical output structure which may be used in the invention, information outputted to the consumer or otherwise may also follow the “information pyramid” structure. Provisions may be included to permit a user to indicate or to permit the automatic generation or estimation of a set of individual, group, or similarly-situated individual or group preferences. Such functionality may even be incorporated when that user is requesting the results for a topic (as a pre-purchase consumer) or at other stages in the process. This may facilitate an ability to list promotional discounts or the like. Further, it may even display information which the present invention's business customers have previously requested or information such as the present invention make available to other similarly situated types of user (that is, one searching a particular topic, a set of topics, or a category or set of categories, having similar past history, or any combination or permutation of such or other criteria). Provision may also be made to permit the user to turn this feature on or off at any time as well.

Further, perhaps if the user has permitted or requested, a subset of responses may be aggregated to form a result. This subset may be based on any one or several of a multitude of criteria. There may even be included a factor or selection which permits the user to view responses from others similarly situated. In embodiments incorporating a feature permitting users to contribute many opinions on many products/services, the present invention may also match responses among accounts. Thus a profile may be formed based solely on responses, without the need for any personally identifying information. When displaying results for a requestor, the present invention may even use these profiles to select a subset of responses which may be automatically or otherwise determined as being perhaps more particularly relevant to the consumer when displaying a result. Internal processes may provide a variety of capabilities automatically or on selection by the user, of course. Additionally, the user may have an opportunity to supply demographic information in order that results may also be further filtered by a demographic profile or other means. Further, the user may select a response profile using a host of both objective or subjective criteria (e.g., no answers/only answers from people who say they do/do not like a particular product or service).

The choice of survey format may be designed to address more than—and maybe important beyond—just statistical accuracy issues. For example by using a binary (yes/no with or without a “neutral,” or positive/negative with/or without a “neutral” option, or any format involving presentation of a few options) rating system, not only is it easier for the user to interact with, but it may also facilitate an easier set of statistical operations on the data. So too short phrases may be used for describing a product's or service's good and bad points (e.g., “pro's” and “con's”). Such phrases may be preselected (such as from a pull down menu or the like), or may be designed to permit consumer choices, or both. Restricting the user's input during the satisfaction survey may be used and may allow the present invention to provide a response tailored to or from other users similarly situated when displaying results.

Users may be prevented from viewing the “consensus” results for a topic unless they have “credits” in their account. They may acquire credits by contributing their opinion(s) on any topic(s). This may be done in a pyramid or hierarchical structure. They may contribute at the basic level (yes/no overall), at the detailed level (yes/no to aspects such as Price, Quality, Features), at the Pro/Con level, or at the 1-on-1 level. Further, specific categories may even provide a particularly appropriate list of aspects for that type of product or service (e.g., for a movie it may request a yes/no or other input for Plot, Acting, and Production; for a service it may request a yes/no or other input for Price, Quality, and Timing). Each level may then award successively higher numbers of credits. Credits may be required to view results. Users may even only be permitted to view results according to the level at which they are contributing. It may even be designed to amount to a policy of “you only get out what you put in.” It may be designed to result in the present invention effectively having a policy force driving the expansion of the topic and review database. Users may also be allowed to add a topic which is not already listed to engender expansion of the database; stock may be issued to an initial set of consumers participating (such as the first 10,000 consumers); free information page storage may be provided for a limited time to early producers participating (such as for the first 6 months).

Through the various embodiments described, consumers may freely exchange gratification data or opinions and specific questions about products and services without fear of exposing themselves to “spam” or other unwanted communications. They may also have complete control over the viewing of advertising or promotional messages from manufacturers and service providers. When they are shopping and willing to consider promotional discount messages, they may turn on that preference. Otherwise, they may have the capability of not being exposed (either at the web site or in any other manner) to advertising or other messages. Furthermore, it may be designed so that pre-purchase consumers may get a much higher quality projection of what their satisfaction level might be if they made a particular purchase, by virtue of the correlation of their survey contributions with other users'. The term purchase as used herein is defined to encompass activity beyond the buying of a product; it is also to include utilization of services and product use including but not limited to rental, “test” use, experimental use, and gratuitous use, and the like. The ease of use, the anonymity available, and other features in embodiments of the present invention may be designed to result in much higher participation levels, thus further increasing the value, objectivity and quality of the results.

It may also be designed such that producers may benefit without detriment to consumers. Producers may pay to participate or for data (again, likely anonymous) by having known purchaser targets for their incentives. As but one example, a user who is requesting the results for a topic is almost certainly about to purchase in that category. Producers would save an enormous amount of money and effort by shifting some of their advertising budget to a set of web site displayed incentive messages or advertising. As may be appreciated, the present invention may provide a target audience which is much smaller and of much higher quality than a typical advertising audience. Embodiments may also be designed such that producers may also achieve a higher response level by using the invention's ability to manage the satisfaction aspects of their product registration survey process. Business methods may provide for revenue from a variety of sources, be they consumer based, advertiser based, or producer based. As to the latter (which is preferred due to factors mentioned elsewhere) individual revenue items such as consumer activity reports, producer page storage, producer page views, producer page click through, producer initiated notification, consumer initiated notification, coupon and promotion charge, survey charges, and even advertising charges among other items may be included. As mentioned earlier, the system may be designed to capitalizes on people's innate tendency to participate more willingly when it is quick, simple, and anonymous.

Some advantages or designs may include, but not be limited to, the following:

No personally identifying information may be required;

Users may benefit from the web's potential with increased security;

No banner advertising may be displayed;

Designs such that users are not distracted from their purpose;

Designs through which users must contribute to earn the ability to extract (the “you only get out of it what you put into it” slogan or concept);

Designs to promote or make available only higher quality data;

Designs incorporating a more simple binary format;

Designs incorporating short phrase options;

Designs incorporating managed contact options;

Designs making interactions easier, and/or results more objective;

Capabilities for similarly situated consumer filtering based on statistical response profiles which may yield higher quality answer for each user;

User controlled “spam” /promotional discounts/incentives/ advertising capabilities;

A large variety of other producer-consumer interaction models; and

Certain consumer anonymity which may lead to higher response rates and higher quality responses.

As can be easily understood from the foregoing, the basic concepts of the present invention may be embodied in a variety of ways. It involves both data acquisition and/or presentation techniques as well as programs or configured devices to accomplish the appropriate interaction. In this application, interaction techniques are disclosed as part ofthe results shown to be achieved by the various options described and as steps which are inherent to utilization. They are simply the natural result of utilizing the methods as intended and described. In addition, while some embodiments are disclosed, it should be understood that these not only accomplish certain methods but also can be varied in a number of ways. Importantly, as to all of the foregoing, all of these facets should be understood to be encompassed by this disclosure.

The discussion included in this is intended to serve as a basic description. The reader should be aware that the specific discussion may not explicitly describe all embodiments possible; many alternatives are implicit. It also may not fully explain the generic nature ofthe invention and may not explicitly show how each feature or element can actually be representative of a broader function or of a great variety of alternative or equivalent elements. Again, these are implicitly included in this disclosure. Where the invention is described in program-oriented terminology, each element of the program implicitly performs a function. Apparatus claims may not only be included for the program described, but also method or process claims may be included to address the functions the invention and each element performs. Neither the description nor the terminology is intended to limit the scope of the claims included in this full, non-provisional patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure,

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of the act of “prompting” should be understood to encompass disclosure of a “prompt” element—whether explicitly discussed or not—and, conversely, were there only disclosure of a “prompt,” such a disclosure should be understood to encompass disclosure of the act of “prompting,” and even a means for “prompting.” Such changes and alternative terms are to be understood to be explicitly included in the description.

Any acts of law, statutes, regulations, or rules mentioned in this application for patent; or patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of Information Disclosure Citation or other information statement filed with the application are hereby appended and hereby incorporated by reference, however, as to each ofthe above, to the extent that such information or statements incorporated by reference might be considered inconsistent with the patenting of this/these invention(s) such statements are expressly not to be considered as made by the applicant(s).

Thus, the applicant(s) should be understood to have support to claim at least: i) each of the programs or systems as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, and ix) methods and apparatuses substantially as described hereinbefore and with reference to any of the accompanying examples, x) the various combinations and permutations of each ofthe elements disclosed, xi) processes performed with the aid of or on a computer or computing device as described throughout the above discussion, xii) a programmable apparatus as described throughout the above discussion, xiii) a computer readable memory encoded with data to direct a computer or computing device comprising means or elements which function as described throughout the above discussion, xiv) a computer or computing device configured as herein disclosed and described, xv) individual or combined subroutines and programs as herein disclosed and described, xvi) the related methods disclosed and described, xvii) similar, equivalent, and even implicit variations of each of these systems and methods, xviii) those alternative designs which accomplish each of the functions shown as are disclosed and described, xix) those alternative designs and methods which accomplish each of the functions shown as are implicit to accomplish that which is disclosed and described, xx) each feature, component, and step shown as separate and independent inventions, and xxi) the various combinations and permutations of each of the above. In this regard it should be understood that for practical reasons and so as to avoid adding potentially hundreds of claims, the applicant may eventually present claims with initial dependencies only. Support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In addition, the claims set forth in this application are hereby incorporated by reference as part ofthis description ofthe invention, and the applicant expressly reserves the right to use all of or a portion of such incorporated content of such claims as additional description to support any of or all ofthe claims or any element or component thereof, and the applicant ftirther expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising,” are intended to imply the inclusion of a stated element or step or group of elements or steps but not the exclusion of any other element or step or group of elements or steps. Such terms should be interpreted in their most expansive form so as to afford the applicant the broadest coverage legally permissible.

What is claimed is:

1. A method for presenting consumer data, comprising the steps of:
a) establishing a consumer purchase database including consumer purchase information;
b) establishing an access threshold credit value associated with some aspect of said consumer purchase database;
c) providing an avenue for user access to said consumer purchase database;
d) permitting communication by a user associated with said consumer purchase database;
e) obtaining identification information of said user;
f) comparing said identification information with registrant information;
g) determining that a consumer purchase database credit value associated with said user exceeds said access threshold credit value;
h) authorizing access by said user to at least a portion of said consumer purchase database;
i) prompting said user for product identification input;
j) comparing said product identification information with said consumer purchase database;
k) providing consumer data to said user; and
l) adjusting said consumer purchase database credit value of said user.

2. A method for presenting consumer data as described in claim 1 wherein said step of providing consumer data comprises the step of providing a format of information that is immediately assimilatable.

3. A method for presenting consumer data as described in claim 1 wherein said step of adjusting said consumer purchase database credit value of said user comprises the step of building credits through product information input.

4. A method for presenting consumer data as described in claim 1 wherein said step of comparing said product identification information input with said consumer purchase database comprises a step selected from the group consisting of: accepting scanned Universal Product Code information input, accepting number input, accepting Universal Product Code information input, accepting product manufacturer input, accepting product category input, and accepting voice input.

5. A method for presenting consumer data as described in claim 1 wherein said step of permitting communication by a user comprises the step of accepting a cell phone access.

6. A method for presenting consumer data as described in claim 1 and further comprising the step of scanning product identification information through an integral cell phone feature.

7. A method for presenting consumer data as described in claim 3 wherein said step of building credits through product information input comprises the step of obtaining simplified product information input.

8. A method for presenting consumer data as described in claim 7 wherein said step of obtaining simplified product information input comprises the step of prompting a binary input.

9. A method for presenting consumer data as described in claim 8 wherein said step of prompting a binary input comprises the step of prompting an input selected from a group consisting of a positive input, a negative input, and a neutral input.

10. A method for presenting consumer data as described in claim 8 wherein said step of prompting a binary input comprises the step of prompting sequenced input.

11. A method for presenting consumer data as described in claim 2 wherein said step of providing consumer data to said user comprises the step of providing data having a hierarchical information structure.

12. A method for presenting consumer data as described in claim 3 wherein said step of building credits through product information input comprises the step of building a type of credit for similar input.

13. A method for presenting consumer data as described in claim 1 wherein said step of providing consumer data comprises the step of establishing an integrity tag.

14. A method for presenting consumer data as described in claim 1 and further comprising the step of forming a user profile based on information exchanged.

15. A method for presenting consumer data as described in claim 11 wherein said step of providing data having a hierarchical information structure comprises a step selected from the group consisting of: offering a manufacturer's input, offering a promotional discount, and offering conditional information.

16. A method for presenting consumer data as described in claim 3 and further comprising a step selected from a group consisting of: obtaining product input, seeking a binary input, seeking positive/negative input, seeking positive/negative/neutral input, providing said consumer data fast, providing said consumer data in at most five seconds, and providing said consumer data immediately.

17. A method for presenting consumer data as described in claim 3 and further comprising the step of determining the permissibility of continued user access.

18. A method for presenting consumer data, comprising the steps of:
a) establishing a consumer purchase collection of consumer purchase determinants;
b) providing an avenue for user access to said consumer purchase collection;
c) permitting communication with said consumer purchase collection by a user;
d) prompting said user for product identification input;
e) obtaining product identification input from said user; and
f) providing at least a part of said consumer purchase determinants to said user.

19. A method for presenting consumer data as described in claim 18 wherein said step of obtaining product identification input from said user comprises a step selected from the group consisting of: accepting scanned Universal Product Code information input, accepting number input, accepting Universal Product Code information input, accepting product manufacturer input, accepting product category input, and accepting voice input.

20. A method for presenting consumer data as described in claim 18 wherein said consumer purchase determinants are selected from the group consisting of: consumer information, coupons, and manufacturing information.
